(19) United States
(12) Patent Application Publication
(10) Pub. No.: US 2025/0341344 A1
(43) Pub. Date: Nov. 6, 2025

(54) SOLAR CONCENTRATOR ENERGY HARVESTING SYSTEM

(71) Applicant: Terrajoule Energy Inc., Vancouver (CA)

(72) Inventors: Stephen James BISSET, Palo Alto, CA (US); Frédéric BOURGAULT, Vancouver (CA); Ryan BRYDE, Vancouver (CA); John Gordon CROFTS, Vancouver (CA); Piotr Leszek KOSTKA, Vancouver (CA); Jason Andrew Walter BEATCH, Maple Ridge (CA); Mojtaba KHEIRI, Verdun (CA)

(21) Appl. No.: 18/871,112

(22) PCT Filed: May 30, 2023
(86) PCT No.: PCT/CA2023/050742

§ 371 Date: Dec. 2, 2024

Related U.S. Application Data
(60) Provisional application No. 63/348,918, filed on Jun. 3, 2022.

(51) Int. Cl. F24S 25/12; F24S 10/70; F24S 20/20; F24S 23/70; F24S 25/37; F24S 25/70

(52) U.S. Cl. CPC F24S 25/12; F24S 10/74; F24S 20/20; F24S 23/80; F24S 25/37; F24S 25/70; F24S 2023/832; F24S 2023/872

(57) ABSTRACT

An energy harvesting system is disclosed including a plurality of beams connected to form a structural frame, and a plurality of solar concentrator panels mounted on the structural frame to provide a solar concentrator array for reflecting solar radiation onto a plurality of receiver tubes configured to transport a heat transfer fluid to be heated. The beams are configured to support a mobile manipulator for travel along the structural frame for performing at least one operation on the array. A mirror apparatus used in a solar concentrator panel is also disclosed and includes an elongate thin-walled closed structural beam, and a mirror extending along and mounted to a surface of the closed structural beam in a transversely deformed condition to cause the mirror to have a transverse curvature that is selected to focus the solar radiation onto a receiver tube.

### BACKGROUND

### 1. Field

This disclosure relates generally to solar concentrators and more particularly to a solar concentrator array configured to reflect solar radiation onto a plurality of receiver tubes for heating a heat transfer fluid.

### 2. Description of Related Art

Solar concentrator systems generally use mirrors or lenses to concentrate solar radiation from the sun onto a receiver to generate heat. The heat generated in the receiver may be used to drive a heat engine such as a steam turbine to generate electrical energy. A solar concentrator having an area that is the size of an American football field would generate an electrical power of about 0.24 MW. As such, the construction of even a modest 10 MW generation plant would be quite a considerable undertaking due to the need to ship and install solar concentrator equipment that would cover an area of about 42 football fields.

### SUMMARY

In accordance with one disclosed aspect there is provided a solar energy harvesting system. The system includes a plurality of beams connected to form a structural frame and a plurality of solar concentrator panels mounted on the structural frame to provide a solar concentrator array configured to reflect solar radiation onto a plurality of receiver tubes, the plurality of receiver tubes being configured to transport a heat transfer fluid to be heated by the solar radiation. The plurality of beams are configured to support a mobile manipulator for travel along the structural frame, the mobile manipulator being configured to perform at least one operation on the solar concentrator array.

The plurality of beams may include a plurality of regularly spaced apart longitudinally extending rail beams, and a plurality of cross beams connecting between adjacent rail beams.

The plurality of solar concentrator panels may be mounted between adjacent pairs of rail beams to provide the solar concentrator array.

The rail beams may be configured to guide and support the mobile manipulator straddled between an adjacent pair of rail beams for travel along the rail beams.

The plurality of beams may be connected to provide a continuously connected structural frame. structural frame may include a plurality of mounting locations and an associated plurality of posts may be disposed at an operating site to support the structural frame at respective mounting locations in a desired orientation with respect to an incidence path of the solar radiation.

The plurality of beams may include longitudinally extending rail beams and transversely extending cross beams and wherein at least one mounting location may be configured to anchor the structural frame in fixed relation to the associated post, at least one mounting location is configured to constrain transverse movement of the rail beams while facilitating longitudinal movement to accommodate thermal expansion or contraction of the rail beams, and at least one mounting location is configured to constrain longitudinal movement of the cross beams while facilitating transverse movement to accommodate thermal expansion or contraction of the cross beams.

he mobile manipulator may include a height actuator and each mounting location may include a height adjustment configured to be engaged by the height actuator for adjusting a height of the mounting location to level the structural frame.

The mobile manipulator may be configured to generate height alignment signals for aligning the level of the structural frame in a desired orientation with respect to the incidence path of the solar radiation and the height actuator may be responsive to the height alignment signals for adjusting the height of the mounting location.

The plurality of beams may include a plurality of longitudinally extending rail beams configured to support the mobile manipulator for travel along an adjacent pair of rail beams and may further include a feeder track disposed running transversely alongside the rail beams, the feeder track being configured to facilitate positioning the mobile manipulator to access the adjacent pair of rail beams.

The system may include a staging track disposed to provide access between a loading location and the feeder track to facilitate movement of the mobile manipulator onto the feeder track.

The staging track may provide access to a plurality of loading locations disposed in proximity to the staging track and the mobile manipulator may be configured to access any of the plurality of loading locations for loading components.

The mobile manipulator may include an end effector, the mobile manipulator being configured to manipulate the end effector to load one or more components of the solar array at the loading location, transport the one or more components via the staging track to a position on the feeder track that provides access to an adjacent pair of rail beams for movement to an open location within the solar concentrator array, travel along the adjacent pair of rail beams to align with the open location, and manipulate the end effector to place the one or more components into engagement with the structural frame at the open location.

The plurality of solar concentrator panels each may include a prefabricated solar concentrator panel and the end effector may include a panel end effector configured to manipulate one or more of the prefabricated solar concentrator panels.

The end effector may be configured to cause one of independent vertical manipulation and simultaneous vertical manipulation of two prefabricated solar concentrator panels.

The structural frame may include attachment features that are configured to engage with corresponding attachment features on the prefabricated solar concentrator panels to secure the panels in fixed engagement with the structural frame.

The staging track may include an end disposed to provide access to a loading location and the mobile manipulator may be configured to use the panel end effector to load one or more of the prefabricated solar concentrator panels from a stacked plurality of prefabricated solar concentrator panels disposed at the loading location.

The mobile manipulator may include a quick mount connection for mounting one of a plurality of end effectors.

The stacked plurality of prefabricated solar concentrator panels may include prefabricated solar concentrator panels supported by a transport frame configured to support and protect the prefabricated solar concentrator panels during shipping and to facilitate loading by the mobile manipulator.

The receiver tube may be configured to be mounted to a plurality of receiver tube supports connected between adjacent pairs of rail beams and the end effector may include a receiver tube support end effector configured to manipulate one or more of the receiver tube supports.

The structural frame may include receiver tube support attachment features that are configured to engage with corresponding attachment features on the one receiver tube support to secure the receiver tube support to the adjacent pair of rail beams.

The end effector may include a receiver tube end effector configured to manipulate one or more receiver tubes.

The mobile manipulator may include an orbital welder configured to fluidly connect the receiver tube to another already placed receiver tube.

The mobile manipulator may include a drive actuator coupled to one or more wheels of the mobile manipulator to cause the mobile manipulator to travel along the structural frame in response to drive actuator signals, one or more sensors disposed to generate alignment signals with respect to the structural frame, and a controller in communication with the drive actuator and the one or more sensors, the controller being configured to generate the drive actuator signals for controlling movements of the mobile manipulator based on the alignment signals.

The mobile manipulator may include a gantry straddling the adjacent pair of adjacent rail beams and the mobile manipulator may include one or more end effectors configured to perform the at least one operation on the solar concentrator array.

The mobile manipulator may be configured to perform one or more of an installation operation, a transport operation, a cleaning operation, an inspection operation, an alignment adjustment, a repair operation, or a maintenance operation.

Each of the plurality of solar concentrator panels may include a plurality of adjacent elongate mirror strips, each mounted to a transverse rack, each mirror strip may include a mirror structural support having an elongate upper surface, a plurality of mirrors mounted to the upper surface, each mirror having a curvature in the transverse direction that is selected to focus the solar radiation onto a portion of the plurality receiver tubes, and the structural support may be configured for rotation on the transverse rack with respect to the solar radiation to cause the mirrors to direct the solar radiation toward respective portions of the plurality of receiver tubes.

The system may include a mirror actuator coupled to the mirror structural support, the mirror actuator being configured to cause rotation of the mirror structural support based on a changing angle of incidence of the solar radiation for directing the reflected solar radiation toward the portion of the plurality of receiver tubes.

For each individual mirror strip in the solar concentrator panel, the mirror actuator may be connected to the mirror structural support to align the individual mirror at an angle with respect to the angle of other mirrors in the panel to reflect solar radiation onto the receiver tube.

The mobile manipulator may include a plurality of wheels configured to engage a portion of the rail beams that remains exposed after the plurality of solar concentrator panels have been mounted between adjacent pairs of rail beams to provide the solar concentrator array, the exposed portion of the rail beams being operable to facilitate travel of the mobile manipulator along the rail beams for performing operations on the solar concentrator array following mounting of the solar concentrator panels.

In accordance with another disclosed aspect there is provided a method for performing operations on a structural frame disposed to support a solar concentrator array, the solar concentrator array including a plurality of solar concentrator panels. The method involves supporting a mobile manipulator for travel along the structural frame, causing the mobile manipulator to travel along the structural frame to a location on the structural frame at which at least one operation associated with the solar concentrator array is to be performed, and causing the mobile manipulator to perform the at least one operation at the location.

Causing the mobile manipulator to perform the at least one operation may involve causing the mobile manipulator to perform one or more of an installation operation, a transport operation, a cleaning operation, an inspection operation, an alignment adjustment, a repair operation, or a maintenance operation.

The method may involve receiving signals from one or more sensors disposed to generate alignment signals with respect to the structural frame and causing a controller to generate the drive actuator signals for controlling movements of the mobile manipulator based on the alignment signals.

The plurality of beams may include a plurality of regularly spaced apart longitudinally extending rail beams and a plurality of cross beams connecting between adjacent rail beams and supporting a mobile manipulator for travel along the structural frame may involve receiving and supporting the mobile manipulator straddled between an adjacent pair of rail beams for travel along the rail beams.

Causing the mobile manipulator to travel along the structural frame may involve causing the mobile manipulator to travel along a feeder track disposed running transversely alongside the rail beams and causing the mobile manipulator to align with the adjacent pair of rail beams to access the structural frame.

The structural frame may further involve a staging track disposed to provide access between a loading location and the feeder track to facilitate movement of the mobile manipulator onto the feeder track and may further involve manipulating an end effector of the mobile manipulator to load one or more components of the solar array at the loading location, transporting the one or more components via the staging track to a position on the feeder track that provides access to an adjacent pair of rail beams for movement to an open location within the solar concentrator array, causing the mobile manipulator to travel along the adjacent pair of rail beams to align with the open location, and causing the mobile manipulator to manipulate the end effector to place the one or more components into engagement with the structural frame at the open location.

The plurality of solar concentrator panels each may include a prefabricated solar concentrator panel and causing the mobile manipulator to perform the at least one operation at the location may involve causing the mobile manipulator to manipulate the prefabricated solar concentrator panel to cause the prefabricated solar concentrator panel to engage with the structural frame an open location of the structural frame.

In accordance with another disclosed aspect there is provided a solar energy harvesting system. The system includes a plurality of beams connected to form a structural frame, and a plurality of solar concentrator panels mounted on the structural frame to provide a solar concentrator array configured to reflect solar radiation onto a plurality of receiver tubes, the plurality of receiver tubes being configured to transport a heat transfer fluid to be heated by the solar radiation. The system also includes a plurality of posts disposed at an operating site to support the structural frame at respective mounting locations, at least some of the plurality of posts including a height adjustment actuable to facilitate adjustment of a height of the mounting location to orient the structural frame in a desired orientation with respect to an incidence path of the solar radiation.

Each height adjustment may be configured to be engaged by a height actuator for adjusting a height of the mounting location.

The plurality of beams may be configured to support a mobile manipulator for travel along the structural frame, and the height actuator may be disposed on the mobile manipulator.

The mobile manipulator may be configured to generate height alignment signals for aligning the structural frame in the desired orientation and the height actuator may be responsive to the height alignment signals for adjusting the height of the mounting location.

The mobile manipulator may include a drive actuator coupled to one or more wheels of the mobile manipulator to cause the mobile manipulator to travel along the structural frame in response to drive actuator signals, one or more sensors disposed to generate alignment signals with respect to the structural frame, and a controller in communication with the drive actuator and the one or more sensors, the controller being configured to generate the drive actuator signals for controlling movements of the mobile manipulator based on the alignment signals.

The desired orientation with respect to an incidence path of the solar radiation may include a substantially level condition of the structural frame.

In accordance with another disclosed aspect there is provided a method for leveling a structural frame at an operating site, the structural frame including a plurality of connected beams supported at mounting locations by a plurality of posts. The method involves automatically actuating a height adjustment associated with at least some of the plurality of posts to adjust a height of the mounting location for orienting the structural frame in a desired orientation.

Each height adjustment may be configured to be engaged by a height actuator for adjusting a height of the mounting location.

The plurality of beams may be configured to support a mobile manipulator for travel along the structural frame, and the height actuator may be disposed on the mobile manipulator.

The mobile manipulator may be configured to generate height alignment signals for aligning the structural frame in the desired orientation and the height actuator may be responsive to the height alignment signals for adjusting the height of the mounting location.

Automatically actuating the height adjustment may be performed at a time of installation of the structural frame and at a subsequent time when the automatically adjusting is repeated to compensate for changes in operating site terrain.

The structural frame may be configured to support a plurality of solar concentrator panels to provide a solar concentrator array configured to reflect solar radiation onto a plurality of receiver tubes, the plurality of receiver tubes being configured to transport a heat transfer fluid to be heated by the solar radiation.

In accordance with another disclosed aspect there is provided a solar energy harvesting system. The system includes a plurality of beams connected to form a structural frame, a plurality of solar concentrator panels mounted on the structural frame to provide a solar concentrator array configured to reflect solar radiation onto a plurality of receiver tubes, the plurality of receiver tubes being configured to transport a heat transfer fluid to be heated by the solar radiation. The plurality of beams are configured to support a mobile cart for travel along the structural frame to provide access to the solar concentrator array.

In accordance with another disclosed aspect there is provided a mirror strip apparatus used in a solar concentrator panel for collecting solar radiation, the mirror strip apparatus. The apparatus includes an elongate thin-walled closed box structural beam, and a mirror extending along and mounted to a surface of the structural beam in a transversely deformed condition to cause the mirror to have a transverse curvature that is selected to reflect and concentrate the solar radiation onto a receiver tube, the receiver tube being configured to transport a heat transfer fluid to be heated by the reflected and concentrated solar radiation.

The deformed condition causes the mirror to have one of a circular or a substantially parabolic transverse curved shape.

The mirror may be bonded to a substrate having a similar coefficient of thermal expansion as the mirror.

The substrate may be formed to provide the transversely deformed condition.

The substrate may include one of a glass foam, a porous ceramic, aircrete, a polyurethane foam, a polystyrene foam, a polymer foam, a honeycomb core, a cellulose-based foam, or a compressed cellulose product panel.

The mirror may be mounted to the surface of the structural beam via a plurality of flexures, the flexures configured to provide sufficient compliance in a longitudinal direction to facilitate a difference between thermal expansion of the structural beam and the mirror, and sufficient transverse stiffness to maintain an accurate relative angular positioning of the mirror with respect to the structural beam.

The mirror may be mounted to the surface of the structural beam via a layer of elastomeric adhesive, the layer of elastomeric adhesive configured to provide sufficient compliance in a longitudinal direction to facilitate a difference between thermal expansion of the structural beam and the mirror, and sufficient transverse stiffness to maintain an accurate relative angular positioning of the mirror with respect to the structural beam.

The layer of elastomeric adhesive may be further configured to dissipate energy caused by structural beam vibrations.

The structural beam may include a mounting plate for mounting the structural beam in the solar concentrator panel, the mounting plate configured to provide for rotation of the structural beam about a longitudinal axis extending along a front surface of the mirror.

The mounting plate may be configured for rotation through an angle of at least about +40° to at least about −40° with respect to its angular position at noon to track the incidence angle of the solar radiation through daylight hours at an operating location of the solar concentrator panel.

The mounting plate may include a semi-circular race configured to receive at least two bearings on the solar concentrator panel.

The race and bearings may be configured to provide for self-aligning rotation of the mirror about the longitudinal axis of the structural beam.

The structural beam may include one of a rectangular, trapezoidal, semicircular, or irregular cross section.

The structural beam encloses an interior volume defined by the walls of the beam and the interior volume may be at least partially filled by a low-density core material.

The low-density core material may be bonded to the structural beam.

A width of the mirror and height of the structural beam may be selected to minimize excitation of the beam structural modal frequencies by vortex shedding at frequencies caused by wind circulating over the mirror in a transverse direction.

A width of the mirror and height of the structural beam may be selected to minimize excitation of the beam structural modal frequencies by vortex shedding at frequencies caused by wind travelling over the mirror in a transverse direction.

A width of the mirrors and dimensions of the structural beam may be selected to maximize packing efficiency for shipping the apparatus.

The apparatus may include a lever arm connected to the structural beam, the lever arm being configured to couple to an actuator for changing an angle of the mirror to reflect the solar radiation onto the receiver tube.

The lever arm may be connected to the structural beam via a hinged connection to facilitate collapsing the lever arms into to maximize packing efficiency for shipping the apparatus.

A set of mirrors for a solar concentrator panel, each mirror in the set of mirrors configured as set forth above and having a transverse curvature based on an intended location of the mirror on the solar concentration panel.

Other aspects and features will become apparent to those ordinarily skilled in the art upon review of the following description of specific disclosed embodiments in conjunction with the accompanying figures.

### BRIEF DESCRIPTION OF THE DRAWINGS

In drawings which illustrate disclosed embodiments,

FIG. 1A is a perspective view of an energy generation system including a solar concentrator array in accordance with one disclosed embodiment;

FIG. 1B is a block diagram of the energy generation system shown in FIG. 1A;

FIG. 2A is a perspective view of a portion of a structural frame of the solar concentrator array shown in FIG. 1A;

FIG. 2B is a perspective view of a mounting location and an associated post of the structural frame shown in FIG. 2A;

FIG. 3A is a perspective view of a portion of a solar concentrator array during installation at a site;

FIG. 3B is an exploded perspective view of a mobile manipulator and a feeder carriage used for operations on the solar concentrator array;

FIG. 3C is a perspective view of a stacked configuration of prefabricated solar concentrator panels;

FIG. 4A is a perspective view of a solar concentrator panel used in the solar concentrator array of FIG. 1;

FIG. 4B is a perspective view of an underside of a support beam of an elongate mirror strip shown in FIG. 4A;

FIG. 4C is an exploded cross-sectional view of the elongate mirror strip taken along the line 4C-4C in FIG. 4B;

FIG. 4D is an end view of the elongate mirror strip of FIG. 4A, and

FIG. 4E is a perspective view of a portion of the elongate mirror strip of FIG. 4A.

### DETAILED DESCRIPTION

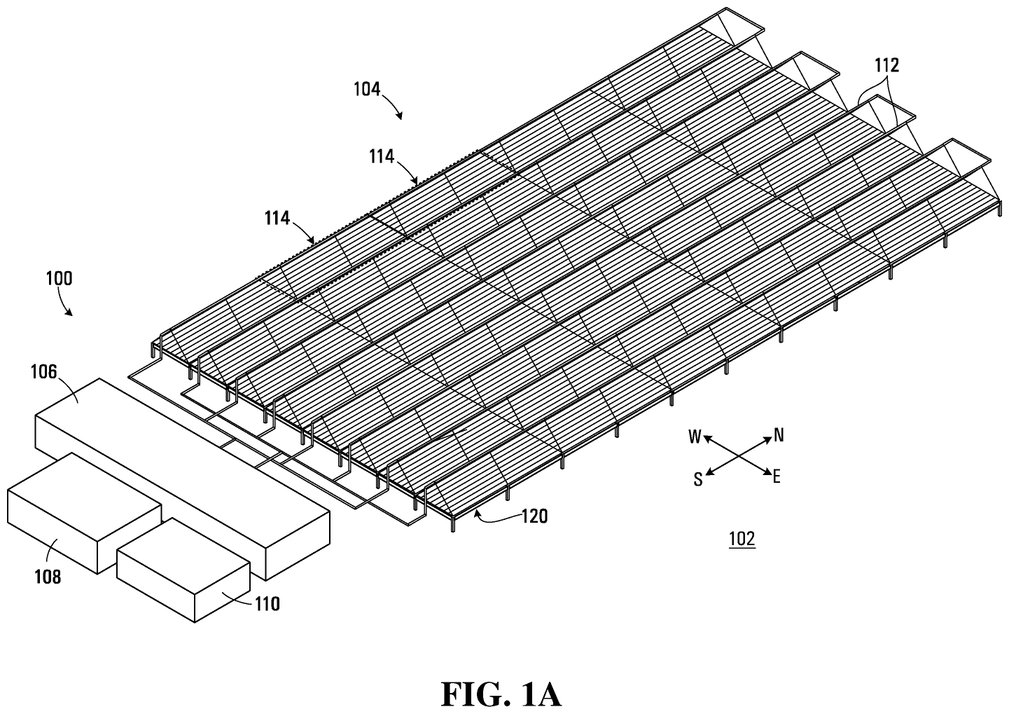

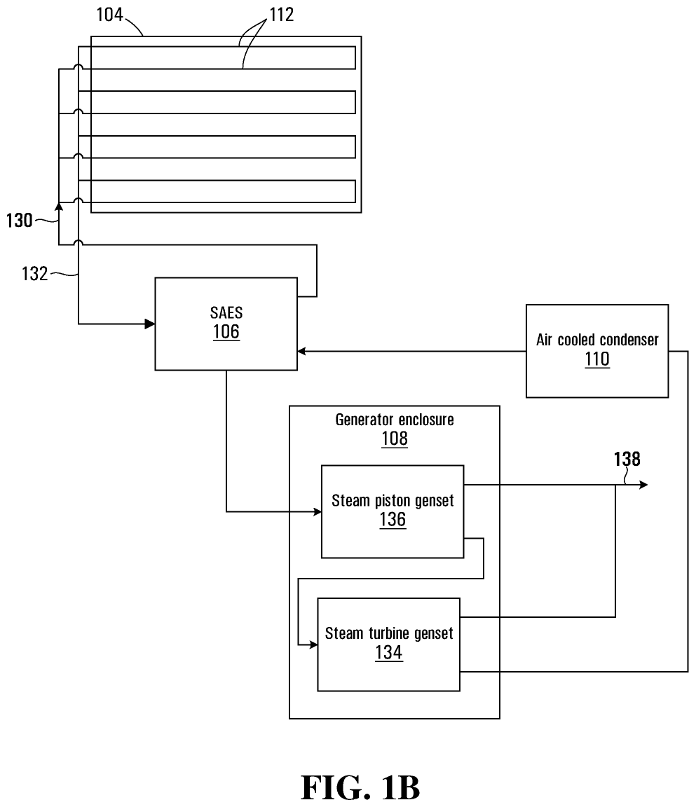

Referring to FIG. 1A, an energy generation system is shown generally at 100. The system 100 is deployed on terrain at an operating site 102 and includes a solar concentrator array 104, steam accumulator energy storage (SAES) 106, a generator enclosure 108, and a condenser 110. The system 100 includes a plurality of beams connected to form a structural frame 120 mounted on the terrain. The solar concentrator array 104 in this embodiment includes a plurality of solar concentrator panels 114 mounted on the structural frame 120. The solar concentrator array 104 is configured to reflect solar radiation onto a plurality of receiver tubes 112. The receiver tubes 112 are configured to transport a heat transfer fluid that is heated by the solar radiation. The heat transfer fluid in either liquid, gaseous, or mixed phase, may be used to extract mechanical work, such as for example rotating an electrical generator. In one embodiment the heat transfer fluid may be water with the phase change producing steam for driving a steam turbine or other steam engine that is used to rotate an electrical generator. In other embodiments the steam may be used for other industrial processes, such as oil sand processing or pressurization of oil wells, for example. In some embodiments other heat transfer fluids such as a fluorocarbon, ammonia, a hydrocarbon, oil, molten salt, or mixtures of liquids may be substituted for water. In one embodiment the solar concentrator panels 114 may include a plurality of elongate mirror strips that are configured to reflect the solar radiation onto the receiver tubes 112. These elongate mirror strips are termed “linear Fresnel” reflectors or mirrors due to their similarity to a Fresnel lens.

The receiver tubes 112 may include two concentric pipes, an inner steel pipe containing the heat transfer fluid and an outer glass tube surrounding the steel pipe. The glass tube may be made of low-iron borosilicate glass to increase its transmittance for solar radiation. The outer surface of the steel pipe has an optically selective surface with a high solar absorptance and low emittance for thermally generated infra-red radiation. The glass tube may be provided with an anti-reflective coating to achieve a higher solar transmittance. The space between the outer glass tube and the inner steel tube may be evacuated. Receiver tubes having a 70 mm diameter are commonly available from several manufacturers. Other configurations of receiver tubes may be used including elements such as multiple parallel adjacent tubes, an insulator above the tube, a flat glass pane underneath to minimize heat loss due to wind, a secondary reflector above to capture radiation that bypasses the tubes, for example.

A block diagram of the system 100 is shown in FIG. 1B. The plurality of receiver tubes 112 receive a water feed at an inlet manifold 130. Solar radiation is reflected by the solar concentrator array 104 onto the receiver tubes to produce steam at a steam output manifold 132. Steam from the steam output manifold 132 outlet is delivered to the SAES 106 for storage of energy in pressurized vessels (not shown). Steam from the manifold 132 is injected into the SAES 106 and condenses into water in the SAES, thus heating and pressurizing the water. In this embodiment, the generator enclosure 108 shown in FIG. 1A houses a steam turbine genset 134 and a steam piston genset 136. When needed to run the steam piston genset 136 and steam turbine genset 134, steam is flashed from the SAES 106 and flows to the steam piston genset 136 and then to steam turbine genset 134. The steam turbine genset 134 and steam piston genset 136 generate electrical energy at an output 138, which may be connected to provide electrical energy to a power grid. The SAES 106 facilitates storage of steam as pressurized water within the pressure vessels during daylight hours when the solar concentrator array 104 is receiving solar insolation. The stored pressurized steam may thus be used to run the steam turbine genset 134 and steam piston genset 136 during overnight hours when it is not possible to generate further steam at the steam output manifold 132, or during any hours of the day or night when it is desired to generate more electrical power than would be possible at that time given the amount of steam being generated at manifold 132. Exhaust steam and water from the steam turbine genset 134 is condensed in the condenser 110 and returned via the SAES 106 as a water feed to the inlet manifold 130. Further details of the system and operation thereof are described in United States patent U.S. Pat. No. 10,047,637 filed on Mar. 26, 2010, and PCT patent application publication WO 2013/074699 filed on Nov. 14, 2012, both of which are incorporated herein by reference in their entirety.

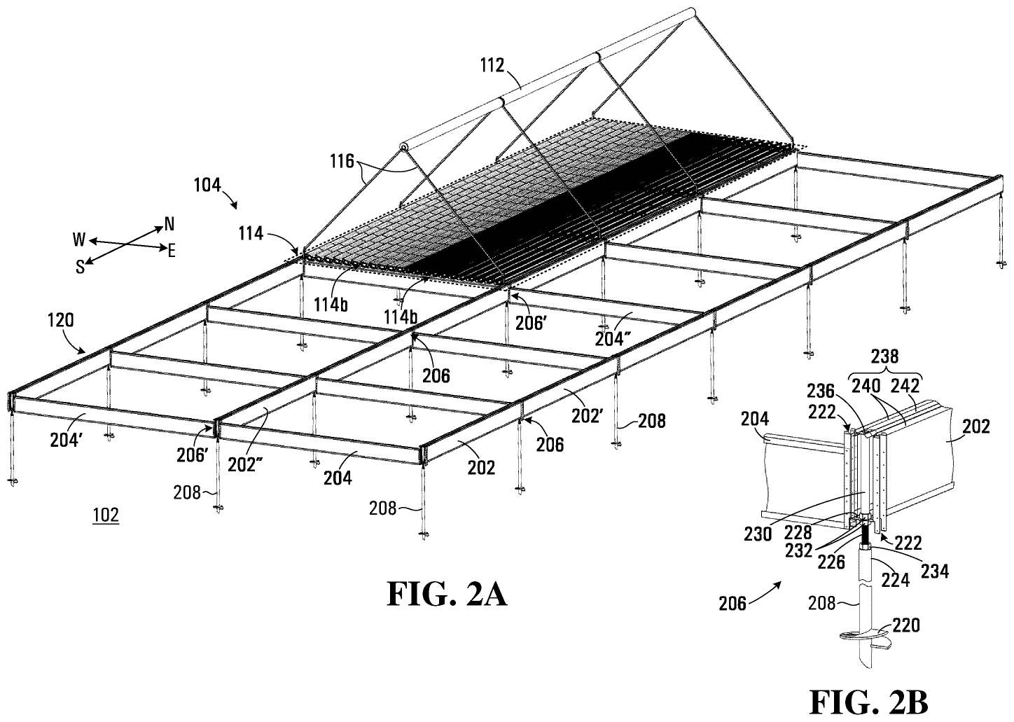

Referring to FIG. 2A, a portion of the structural frame 120 of the solar concentrator array 104 is shown with some of the plurality of solar concentrator panels 114 removed to reveal underlying details. As described in more detail below, the structural frame 120 is configured such that two prefabricated solar concentrator panels 114a and 114b may be installed adjacent to each other and extending between an adjacent pair of rail beams 202. The receiver tubes 112 are mounted on receiver tube supports 116, which are disposed directly above a center line along which the panels 114a and 114b abut. In this embodiment the structural frame 120 includes a plurality of longitudinally extending rail beams 202 that are aligned in a generally north-south direction. Similarly a plurality of cross beams 204 extend transversely and are aligned in a generally east-west direction. In the embodiment shown in FIG. 2A, the plurality of rail beams 202 and cross beams 204 together provide a continuously connected structural frame, which may have a greater longitudinal and transverse extent, depending on an available size of the operating site 102. In other embodiments the structural frame 120 may include separate rail beams 202 that are not connected to provide a continuously connected frame. Alternatively, a separate frame may support one or more solar concentrator panels 114, and the structural frame 120 may be made up of these separate but unconnected frames.

The structural frame 120 also includes a plurality of mounting locations 206 that are supported by an associated plurality of posts 208 disposed on the terrain. The posts 208 support the structural frame 120 at the respective mounting locations 206 in a desired orientation with respect to an incidence path of the solar radiation, which may be assumed to follow a generally east to west direction. The posts 208 are primarily required to support the structural frame 120 and solar concentrator panels 114 in substantially fixed relation with respect to the terrain.

In this embodiment the rail beams 202 are fabricated in sections 202 and 202′ and the mounting locations 206 also act as joints for connecting together the rail beams 202 in a longitudinal direction. Similarly, the cross beams 204 are fabricated in sections 204 and 204′ and are joined at the mounting locations 206, which act as joints for connecting together the rail beams 202 in a transverse direction. The beams 202, 202′, 204, and 204′ are thus joined at the respective mounting locations 206 to provide a continuously connected structural frame 120 that is mutually supporting. The continuously connected nature of the structural frame 120 reduces the amount of material necessary to achieve a required strength and stiffness to hold the solar concentrator panels 114 in sufficient alignment for reflecting the solar radiation onto the receiver tubes 112. The structural frame should also have sufficiently strength and stiffness to support a mobile manipulator for performing operations on the solar concentrator array 104, as described in more detail below.

The outer edges of the solar concentrator array 104 have a relatively small wind facing surface area and profile. Wind loading on the solar concentrator array 104 would thus primarily be in the form of lateral forces on the edges. The continuously connected structural frame 200 distributes these lateral forces across the entire frame and across the plurality of posts 208, while reducing the amount of material required in the frame. The posts 208 are therefore required to operate under primarily vertical loading from the weight of the structural frame 120, plurality of solar concentrator panels 114, and plurality of water fed receiver tubes 112.

In one embodiment the rail beams 202 and cross beams 204 may be fabricated as a thin-walled box with an open core rectangular or other cross-section. The open core may be partially or fully filled with a rigid foam core such as expanded, extruded, or molded polyurethane or polystyrene or a glass foam that maintains the shape of the box to provide structural strength for the beams. The foam in the open core reinforces the box and also performs a damping function that attenuates oscillations of the structural frame 200 under excitation by wind. In one embodiment the box wall may be selected to be sheet steel or any other sheet material, thus providing relatively high strength at low cost. The foam core may be selected from light structural core materials or a honeycomb structure of aluminum, fiberglass composites, or cellulose product, for example.

Referring to FIG. 2B, one of the mounting locations 206 and associated post 208 is shown in greater detail. In this embodiment the post 208 is configured as a ground screw that includes flukes 220 for engaging the underlying terrain to secure the post when turned into the terrain. In other embodiments the post 208 may be a pile that is driven in or otherwise inserted to engage the underlying terrain. Alternatively, for some terrain conditions, the structural frame 200 may be supported on non-penetrating ground pads (not shown) or any other type of foundation.

The mounting location 206 is fabricated from a sheet metal material and includes a pair of transversely oriented channels 222 for receiving and joining the cross beams 204. The cross beams 204 may be riveted, bolted, or spot welded to the channels 222. Alternatively, the mounting locations 206 may include snap-fit features that that are configured to retain correspondingly configured beams. The rail beam 202 is similarly attached to the mounting location 206. The post 208 includes a threaded end 224 for receiving a threaded rod 226, which is locked to the post by a lock nut 234. Alternatively, the threaded rod 226 may be made integral with the posts 208 or may be welded to the post. The mounting location 206 includes a plate 228 that includes an opening and an upwardly extending tube 230 for receiving the threaded rod 226. A pair of nuts 232 above and below the plate 228 may be adjusted to move the structural frame 120 to a desired height above the terrain during installation. When the structural frame 120 is at the desired height, the nuts 232 may be tightened to secure the frame in place. In one embodiment, a tube 230 having an opening 236 at the top of the tube provides access to a coupling (not shown) on the threaded rod 226 for making the height adjustment relative to the post 208 from above.

In some embodiments a longitudinal length of the solar concentrator array 104 shown in FIG. 1A may be about 250 meters or more and the transverse width may be about 100 meters or more for a 2 MW installation. For a structural frame 120 fabricated from a mild steel material, thermal expansion due to changes in ambient temperature could result in relatively large longitudinal or lateral thermally induced displacements of the structural frame 120. For the example of the 250 meter by 100 meter 2 MW installation, the displacement of the edges of the solar concentrator array 104 may be in the range of about 8 centimeters to 26 centimeters or more over a temperature range of −20° C. to +55° C.

One mounting location 206′ may be configured to anchor the structural frame in fixed relation to the associated supporting post in both the north-south and east-west directions. Other mounting locations along the rail beam 202″ that include the mounting location 206′ may be configured to permit movement in the north-south direction, while constraining movement in the east-west direction. Additionally, other mounting locations along the rail beam 202″ that includes the mounting location 206′ may be configured to permit movement in the north-south direction, while constraining movement in the east-west direction. Finally, some of the mounting locations along the beam 204″ may be configured to permit movement in the east-west direction, while constraining movement in the north-south direction.

In one embodiment the anchored mounting location 206′ may be located at a south end of the solar concentrator array 104 proximate the SAES 106 (FIG. 1A) to minimize thermally induced displacement at the south end where the inlet manifold 130 and steam output manifold 132 are connected. The manifolds 130 and 132 are generally constructed from large diameter tubes and are relatively inflexible. In another embodiment, the anchored mounting location 206′ may be located closer to a center of the solar concentrator array 104. This has the effect of reducing the overall thermally induced displacements at the north and south ends of the solar concentrator array 104 but would require that the inlet manifold 130 and steam output manifold 132 be configured to accommodate a larger displacement between the south end of the solar concentrator array 104 and the respective manifolds. In either embodiment, the anchored mounting location 206′ is held in a fixed position while simultaneously preventing the structural frame 120 from twisting about the anchored mounting location by maintaining the alignment of longitudinal beams in the north-south direction and the alignment of the transverse beams in the east-west direction.

In one embodiment the longitudinal and lateral movements may be accommodated by a compliance of the post in these directions. As disclosed above, the posts 208 are primarily configured for vertical loading and may be made sufficiently compliant to permit movement in the longitudinal and lateral directions. In other embodiments the mounting location 206 may be configured to facilitate the necessary longitudinal and/or lateral movements as described above or the structural frame 120 may be supported on the terrain in a manner that permits movement.

In the above description, the SAES 106 and manifolds 130 and 132 have been described as being located at the south end of the solar concentrator array 104, however it should be understood that the system 100 may be alternatively configured and these elements may be located on any end or to the sides of the solar concentrator array 104.

In one embodiment, installation at an operating site 102 may commence with preparation of the site to remove any obstructions and to grade the terrain. The posts 208 may then be driven into the terrain in a regularly spaced apart arrangement based on the spacing of the respective mounting locations 206. In one embodiment the posts may be installed using a post driving implement attached to a construction vehicle such as a tractor or backhoe. Once the posts 208 have been installed, the structural frame 120 may be assembled by connecting the rail beam sections 202 and cross beam sections 204 between the respective mounting locations 20. As disclosed above the beam sections may be riveted, bolted, welded, or retained by a snap-fit fixture to the respective mounting locations 206.

In the embodiment shown in FIG. 2A and 2B, the plurality of rail beams 202 are raised above the level of the cross beams 204. As best shown in FIG. 2B, the rail beams 202 provide an upwardly oriented track surface 238, which in this embodiment is defined by a pair of V shaped grooves 240 formed one either side of a raised central portion 242. The solar concentrator panels 114 are supported on the cross beams 204 extending between the rail beams 202 leaving the V grooves 240 and raised central portion 242 exposed between adjacently disposed solar concentrator panels 114. In this embodiment the rail beam 202 is relatively narrow and the solar concentrator panels 114 are thus mounted in adjacent relation with only a width of the rail beam separating between adjacent edges of the solar concentrator panels. This arrangement minimizes an area of the solar concentrator array 104 that does not contribute to the redirection of solar radiation toward the receiver tubes 112. Some existing solar concentrator arrays require that there be sufficient spacing between adjacent panels to facilitate vehicle access for performing installation or other operations.

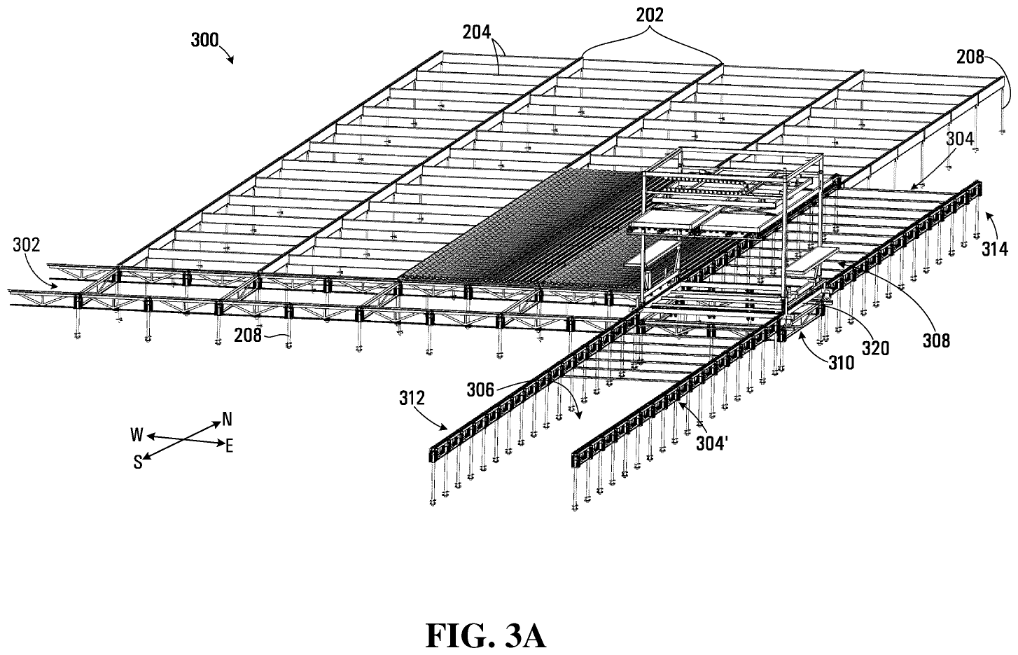

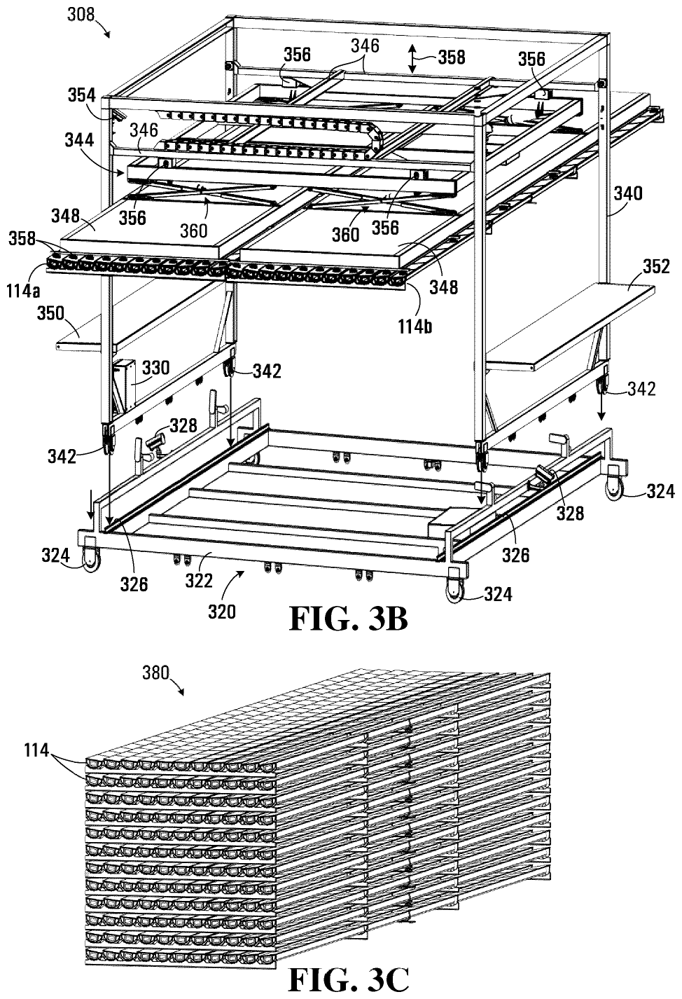

Referring to FIG. 3A, a portion of a solar concentrator array during installation at a site is shown at 300. A plurality of posts 208 have been installed at the installation site 300 along with a plurality of the rail beams 202 and cross beams 204, as described above in connection with FIG. 2A. The installation site 300 includes a feeder track 302 disposed running transversely alongside the structural frame 120 and a staging track 304 running longitudinally alongside the structural frame. The staging track 304 and the feeder track 302 provide access between a loading location 306 and the structural frame 120 as described in more detail below. The staging track 304 includes a second portion 304′ that extends longitudinally and provides access to the loading location 306 for loading components of the solar concentrator array 104. The feeder track 302 and staging track 304 may have a similarly configured track surface to the track surface 238 of the rail beams 202 for facilitating movement of a mobile cart along the feeder track 302, staging track 304, and the rail beams and cross beams 202 and 204. The mobile cart is configured to traverse the structural frame 120 to perform at least a transport operation to transport personnel, tools and/or components to locations on the structural frame 120. In this embodiment the mobile cart is implemented as a mobile manipulator, which is shown generally at 308. The mobile manipulator 308 is configured to traverse the structural frame 120 and to additionally perform various operations at locations on the structural frame, as described in more detail below. The staging track 304 in this embodiment is supported on a greater number of posts 208 than the structural frame 120 to permit heavier loading. The staging track 304 provides access to the loading location 306 and may also provide access to other loading locations to the side of the staging track or at an opposite end 314 of the staging track. An advantage of the staging track is that deliveries of components may be accessed by the mobile manipulator 308 at various locations along the staging track.

The mobile manipulator 308 is shown disposed on a feeder carriage 320 and both are shown vertically separated in FIG. 3B. Referring to FIG. 3B, the feeder carriage 320 includes a frame 322 supported on grooved guide wheels 324 for transverse movement along the feeder track 302. The mobile manipulator 308 includes a frame 340 supported on the pair of longitudinally oriented track sections 326 of the feeder carriage 320 by grooved guide wheels 342 mounted on the frame. The guide wheels 342 of the mobile manipulator 308 are received on the pair of track sections 326 of the mobile manipulator 308 and feeder carriage 320. The guide wheels 342 are oriented to facilitate longitudinal movement of the mobile manipulator 308 onto or off of the track sections 326. The feeder carriage 320 thus moves only in a transverse direction along the feeder track 302. The feeder carriage 320 further includes a pair of longitudinally oriented track sections 326 mounted on the frame 322.

As an example, when the feeder carriage 320 is located at the junction 310 between the feeder track 302 and the staging track 304 as shown in FIG. 3A, the track sections 326 are aligned with the staging track 304 and facilitate movement of the mobile manipulator 308 out of the feeder carriage 320 along the staging track 304. Similarly, when the feeder carriage 320 is moved along the feeder track 302 to align the track sections 326 with any adjacent pair of the plurality of rail beams 202, the mobile manipulator 308 is able to move off the feeder carriage 320 onto the rail beams for travel along any of the adjacent pairs of rail beams 202, thus facilitating access any portion of the structural frame 120 for performing operations on the solar concentrator array 104. In this embodiment the frame 340 is configured as a gantry that straddles between the adjacent pair of rail beams 202 and provides clearance for performing installation of solar concentrator panels 114 or other operations on the solar concentrator array 104.

In the embodiment shown in FIG. 3A, the staging track 304 runs longitudinally alongside the structural frame 120. However in other embodiments, where the installation site 300 permits, the staging track may be configured as an extension of the feeder track 302 for providing access to a loading location. In other embodiments, the feeder track 302 may extend to link a single or multiple solar concentrators 104 to either a single or a plurality of staging track locations.

Referring back to FIG. 3B, the feeder carriage 320 also includes cameras 328 on the right hand side and left hand side of the frame 322 for observing movements of the feeder carriage to either side along the feeder track 302. Similarly, the mobile manipulator 308 includes a pair of cameras 354 (only one is visible in FIG. 3B) that are included for observing movements of the mobile manipulator along the staging track 304. The mobile manipulator 308 further includes a controller 330 for controlling operation and movement of the mobile manipulator 308. The controller 330 interfaces with a plurality of navigation sensors (not shown) that are commonly used for implementing autonomous navigation in industrial processes. Such sensors may include cameras, rotary encoders, hall effect sensors, odometers, inertial measurement units, proximity switches, sonar, laser range finder, radio wave triangulation, magnets, and inductance sensors, as well as other sensors.

In FIG. 3A a single mobile manipulator 308 is shown. However, in some embodiments more than one mobile manipulator 308 may be operated simultaneously on the solar concentrator array 104 to reduce the installation time or time required for other operations.

Referring to FIG. 3B, the mobile manipulator 308 includes an actuated truss 346 that is configured to move vertically within the frame 340, as indicated by the arrow 358. The actuated truss 346 includes a quick mount connection, which in this case includes four connection points 356 mounted on the actuated truss 346. The four connection points 356 may be implemented as actuated T-nut hooks configured to pick up different end effectors via openings in the end effector that are similarly configured to standard shipping container corner castings. The quick mount connection 356 facilitates mounting of various specialized end effectors or tools that are each optimized to perform various operations and maintenance tasks such as picking up and manipulating one or more components. Examples of tasks that an end effector may be configured to perform include installation of solar concentrator panels 114, installation of receiver supports 116, installation of the receiver tubes 112, joining receiver tube sections, leveling of the structural frame 120, performing cleaning operations on the solar concentrator panels 114, as well as placing and welding manifold tubes and other operations.

In the embodiment shown a solar concentrator panel end effector 344 is shown connected to the actuated truss 346 via the quick mount connection 356. The end effector 344 includes two panel grasping mechanisms 348 that are configured to grasp and lift each of the solar concentrator panels 114a and 114b in this case. In the embodiment shown the panel grasping mechanisms 348 each include a plurality of suction cups 358 that are actuated to grasp the panels by activating a vacuum pump in fluid communication with the suction cups.

The panel end effector 344 also includes an actuated scissor mechanism 360 coupled to each panel grasping mechanism 348 for providing further independent vertical movement of each of the solar concentrator panels 114a and 114b that are being manipulated. The actuated scissor mechanism 360 may also provide for smaller and more precise movements of each panel 114 in the vertical direction.

In one embodiment the solar concentrator panels each may be shipped as prefabricated units that are ready to install on the structural frame 120. Prefabrication has the advantage of reducing the on-site assembly work that is required for installing the solar concentrator array 104. The prefabricated solar concentrator panels 114 may be unloaded at the loading location 306 where the mobile manipulator 308 can lift one or more panels using the specialized panel end effector 344 for such task. The mobile manipulator 308 may then transport the panels onto the feeder carriage 320 at the junction 310, and then move to a position on the feeder track 302 that provides access to an adjacent pair of rail beams 202. The mobile manipulator 308 is then able to travel along the adjacent pair rail beams 202 to align with an open location on the structural frame 120. At the open location the mobile manipulator 308 manipulates the end effector 344 to place the prefabricated solar concentrator panels 114a and 114b into engagement with the structural frame. The structural frame 120 may include attachment features (not shown) that are configured to engage with corresponding attachment features on the prefabricated solar concentrator panels to secure the panels in fixed engagement with the structural frame.

In the embodiment shown in FIG. 3A, the staging track portion 304′ includes an end 312 disposed to provide access to the loading location 306. The mobile manipulator 308 may be configured to use the panel end effector 344 to load one or more of the prefabricated solar concentrator panels at the loading location 306. Referring to FIG. 3C, in one embodiment the prefabricated solar concentrator panels 114 may be shipped to the installation site 300 in a stacked configuration 380 of prefabricated solar concentrator panels 114. The prefabricated solar concentrator panels 114 may be held in the stacked configuration 380 by a transport frame (not shown) that is configured to support the panels and prevent shipping damage. In one embodiment the solar concentrator panels 114 and the stacked configuration 380 are sized to fit in a standard shipping container.

The stacked configuration 380 of panels 114 may be unloaded as a whole from its transport and placed at the loading location 306 in the stacked configuration 380, where the mobile manipulator 308 is able to load one panel 114 at a time from the top of the stack 380. The gantry configuration of the frame 340 provides clearance for loading an uppermost prefabricated solar concentrator panel 114 from the stack 380.

The above embodiments of the structural frame 120 and mobile manipulator 308 have the advantage of providing for travel along the structural frame to perform installation of solar concentrator panels 114 that make up the solar concentrator array 104. The mobile manipulator 308 may also be configured to carry out various other operations on the solar concentrator array 104. For example, in one embodiment the mobile manipulator 308 may have a receiver tube support end effector installed in place of the end effector 344 that is specially configured to manipulate and transport a plurality of the receiver tube supports 116 to installation locations within the solar concentrator array 104. The structural frame 120 may include receiver tube support attachment features (not shown) that are configured to engage with corresponding attachment features on the one receiver tube support to secure the receiver tube support to the adjacent pair of rail beams 202. In another embodiment the mobile manipulator 308 may have a receiver tube end effector installed in place of the end effector 344 that is configured to load and transport a plurality of receiver tube sections. The receiver tube sections may be installed on already placed receiver tube supports 116. In one embodiment the mobile manipulator 308 may be further configured with a different end effector to fluidly connect each subsequent receiver tube to another already placed receiver tube. For example, the mobile manipulator 308 may be configured with an orbital welder for welding receiver tube sections.

The mobile manipulator 308 may be configured to perform various other operations by selecting and installing a different end effector 344. For example, the mobile manipulator 308 may be configured to perform a cleaning operation on the solar concentrator panels 114. In one embodiment the mobile manipulator 308 may be configured with a frame leveler end effector and sensors for generating height alignment signals for aligning the structural frame 120 in a horizontal orientation with respect to the incidence path of the solar radiation. The degree of alignment required may be sufficient to substantially level the structural frame 120 to an extent made necessary by alignment tolerances required for effective operation of the solar concentrator array 104. Following installation of the posts 208 and structural frame 120 as described above, the mobile manipulator 308 may be moved along each pair of rail beams while causing the height actuator end effector to adjust the height at each post 208 to align the structural frame 120 based on the height alignment signals generated by the sensors. While the structural frame has been described herein in the context of mounting and supporting a plurality of solar concentrator panels 114, the structural frame and height adjustments associated with the posts 208 may be employed on an alternative structural frame that is configured to support components other than solar concentrator panels. Such components may include, for example, photovoltaic panels in a photovoltaic energy generation system, structural frames used in greenhouses for supporting growing plants etc., structures for supporting a tent, or other structural frames that act as a support foundation.

Referring back to FIG. 3B, in the embodiment shown the frame 340 includes a pair of laterally extending platforms 350 and 352 that permit an operator to stand and ride along on the mobile manipulator. Due to the minimal separation between adjacent panels in the solar concentrator array 104, access to the panels 114 is limited and the mobile manipulator 308 provides a useful function in transporting operating personal to inspect areas of the solar concentrator array 104. In one embodiment the mobile manipulator 308 may be equipped with one or more cameras that may be used to capture images of the solar concentrator array 104, which may be relayed back to a controller for viewing by a remotely located operator.

Over time, there may be an accumulation of debris and other contaminants on the surface of the panels 114 that may reduce solar concentration efficiency. The mobile manipulator 308 may be configured to perform a periodic cleaning function on the panels 114. Additionally, for panels including elongate mirror strips, the mirrors may over time become misaligned with respect to the receiver tubes 112. The mobile manipulator 308 may be configured with actuators and sensors that are configured to perform an alignment of the mirrors. Movement of the underlying terrain through the seasons may disturb mirror alignment and the measurement and adjustment of the structural frame 120 levels and mirror alignments may be performed automatically or semi-automatically. This may also permit the structural frame to be less rigid and stable over time since the automated alignment is effectively able to counteract small movements of the frame over time.

Other maintenance or repair operations may be performed either by the mobile manipulator 308 or by operating personnel using the mobile manipulator to access the solar concentrator array 104. In some embodiments the mobile manipulator 308 may be manually or semi-automatically controlled by a human operator. However, in other embodiments the mobile manipulator 308 may be configured to perform most or all operations automatically.

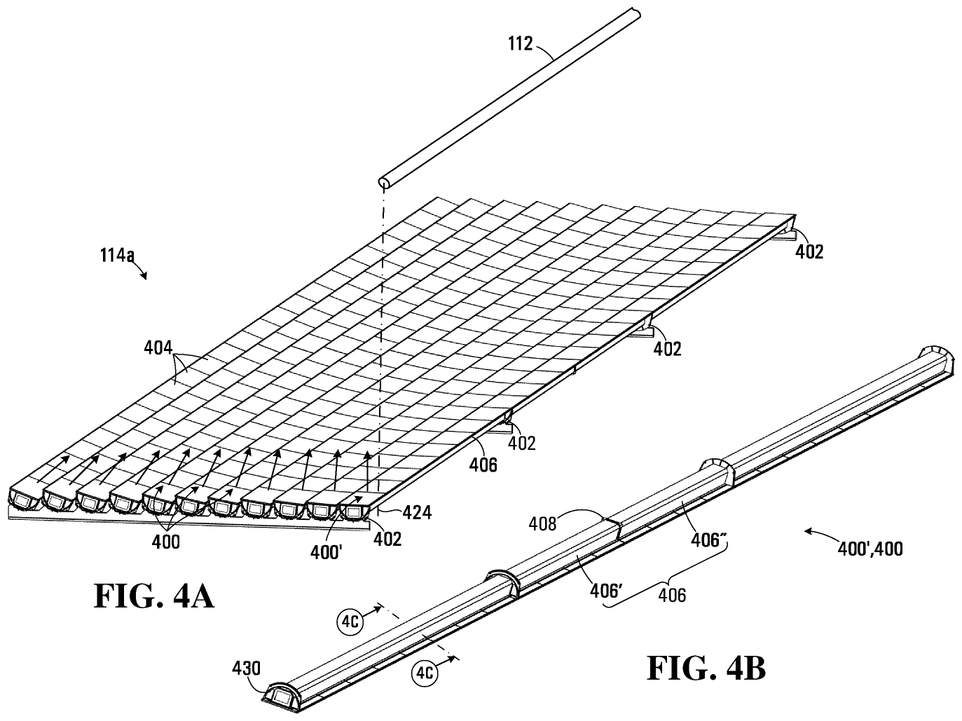

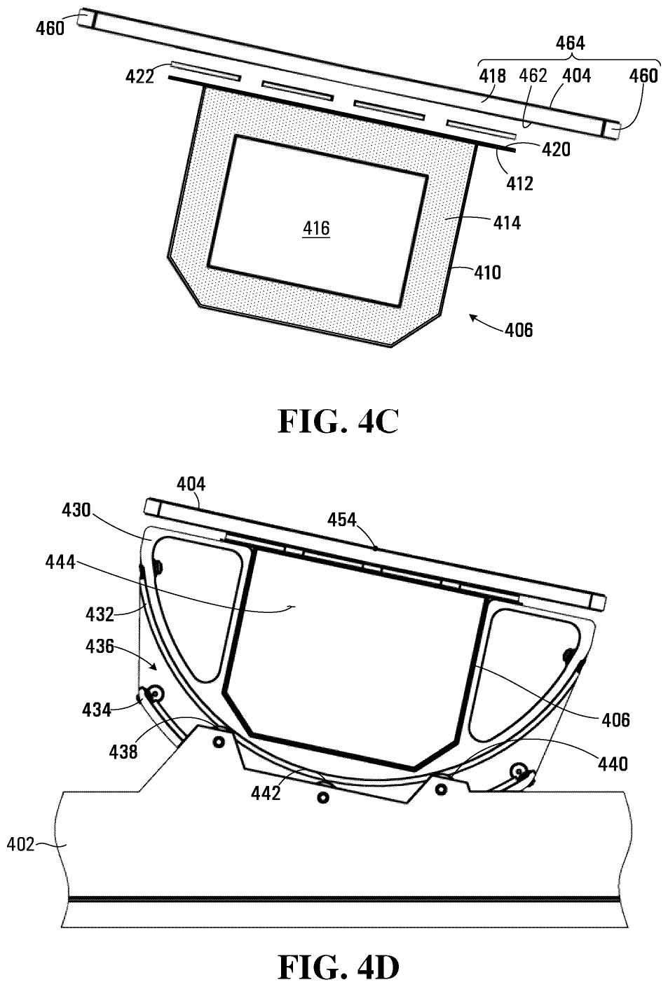

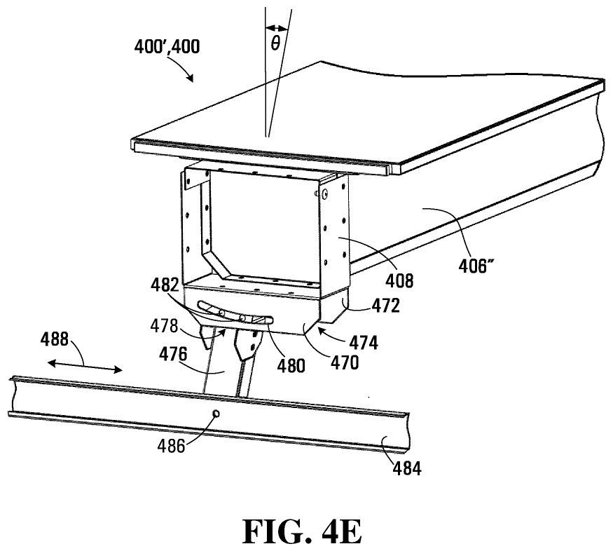

One of the prefabricated solar concentrator panels 114a from the stack 380 is shown in isolation in FIG. 4A. The solar concentrator panel 114a includes a plurality of adjacent elongate mirror strips 400. In this embodiment there are 11 mirror strips 400 in each solar concentrator panel 114a, but in other embodiments there may be a greater or lesser number of mirrors in each panel. In one embodiment the mirror strips 400 may be about 12 meters in length and the panels 114a and 114b may be about 2.25 meters in width. While the choice of the panel dimensions may be varied from this example, the width and length of the mirror panels 114a and 114b in this embodiment were selected to stack and fit tightly into a 40 foot container to maximize shipping efficiency. At the same time the width of the panels 114a and 114b and height of the receiver tubes 112 above the panels were selected to use with an approximately 70 mm diameter receiver tube, which is a commonly manufactured tube size.

Still referring to FIG. 4A, the mirror strips 400 are mounted on transverse racks 402, which in this embodiment are longitudinally spaced apart by the same spacing as the cross beams 204 to facilitate mounting to the cross beams. For the embodiment shown in FIG. 2A, the transverse rack 402 and the prefabricated solar concentrator panel 114a thus has a width of approximately half off the spacing between adjacent rail beams 202.

When the solar radiation incidence is from directly above the solar concentrator panel 114a, a surface of a first mirror 400′ is held facing substantially perpendicular to vertical axis 424 passing through the receiver tube 112 (shown in part in FIG. 4A). Each successive mirror to the left of the mirror 400′ on the panel 114a is rotated by a slightly greater angle to the vertical axis 424 to direct the solar radiation contribution from the mirror onto the centrally located receiver tube 112. The angle of each mirror strip 400 is controlled through the day to maintain the reflection of the incident sun light from the mirror on the receiver tube 112 as described in more detail below.

Each of the mirror strips 400 shown in FIG. 4A includes a plurality of mirrors 404 mounted along an elongate support beam 406. Referring to FIG. 4B, an underside of the support beam 406 is shown and in this embodiment is fabricated in two sections 406′ and 406″. The sections 406′ and 406″ may be joined together by adhesive and/or rivets at a rivet plate 408. In other embodiments the support beam 406 may be fabricated as a continuous unitary beam to minimize parts count and number of assembly operations.

An exploded cross-section of an embodiment of the support beam 406 is shown in FIG. 4C. The cross section is taken along the line 4C-4C in FIG. 4B and the cross-sectional view has been rotated from the orientation of the support beam 406 shown in FIG. 4B to be in a more representative operating orientation for one of the mirror strips 400. The support beam 406 is also shown in end view in FIG. 4D. Referring to FIG. 4C, the support beam 406 is configured as an elongate, generally rectangular, structural beam. The support beam 406 has ends closed by an end cap 444 (shown in FIG. 4D) covering each of its open end to close the beam box structure primarily to ensure structural integrity and maintain torsional stiffness. The end caps also prevent water and other debris ingress over time which could affect performance. The support beam 406 includes a thin-walled trough 410 joined to a thin flat top plate 412 that extends laterally to either side of the thin-walled trough. The top plate 412 provides an outwardly oriented mounting surface 420 for mounting the plurality of mirrors 404. In one embodiment, the trough 410 may be fabricated by bending galvanized steel sheet material and joining the bent material to the flat top plate 412 and the end caps 444 to form the closed box structural beam 406. The components constituting the trough 410 and top plate 412 may be joined using structural adhesive, and/or other mechanical means such as crimping, welding or riveting. In other embodiments, the support beam 406 may have a trapezoidal, semicircular, or irregular cross section and may also include structural inner ribs at regular longitudinal intervals.

The support beam 406 also includes a core material 414, which in this embodiment only partly fills an interior volume of the support beam 406 leaving a void 416 extending longitudinally through the beam. In other embodiments, the enclosed volume within the beam 406 may be completely filled by the same core material, or core material of lower density, thus eliminating the void 416. The core material 414 may be a low-density foam material that is bonded to the inner surfaces of the trough 410, top plate 412 and end caps 444 mainly to provide out of plane rigidity to the thin walled trough and top plate. In some embodiments, out of plane rigidity of the thin top plate 412 may be alternatively provided by its mechanical connection to the mirrors 404, in which case the core material on the inner surface of the top plate 412 may be eliminated to save mass and cost.

The constitution and physical properties of the core material 414, and the material and wall thickness of the support beam 406 may be selected to both meet storm wind critical loads, as well as to alleviate excitation of structural modal resonance frequencies of the mirror strip 400. The excitation of resonance frequencies of the mirror strips 400 may be due to wind induced excitation from vortex shedding phenomenon. Generally, in order to prevent deleterious effects of structural resonance, it is an advantage to have the modal vibration frequencies of the elongate mirror strip 400 sufficiently separated, either sufficiently far below or more typically sufficiently far above the excitation frequencies resulting from wind passing over the mirror.

In order to maximize the stiffness of the support beam 406 while minimizing the amount of material used, material (for example steel) may be distributed to locations where it will have the most impact in supporting the structural loads. This optimization leads to thin walled tube-like structures, where the material is distributed as far as possible from the beam center of area to provide a light and stiff structural beam. However, thin walls may be relatively easily bent out of plane when the structural beam 406 is under load, which may result in catastrophic failure of the beam (i.e. buckling). The core material 414 is effective in maintaining the thin walls of the support beam 406 in their original cross-sectional configuration so that the stiffness of the beam, and thus its buckling load, will be increased closer to the beam theoretical yield strength associated with an un-deformed cross-section. This also has the effect of increasing modal vibration frequencies of the structural beam 406 to values closer to a predicted modal vibration frequency value based on a rigid cross-section. Acoustic wall vibrations are also substantially reduced. The core material 414 may also provide some energy dissipation for damping the beam modal frequencies.

The plurality of mirrors 404 in this embodiment are longitudinally segmented into lengths as shown in shown in FIG. 4A to avoid differential thermal expansion problems between the glass mirror and the support beam 406 that may be encountered with longer lengths over a wide range of environmental temperature changes. The plurality of mirrors 404 are adhesive bonded to a rigid substrate 418, backed by another skin layer 462 that is bonded on an opposite surface of rigid the substrate 418 to form a light and rigid composite sandwich mirror structure 464. In some embodiments, the substrate material 418 may be pre-shaped in a curvature that provides and maintains the desired curvature for the plurality of mirrors 404. In one embodiment the backing 462 may be glass of similar thickness to the plurality of mirrors 404 or another material having a similar coefficient of thermal expansion to the plurality of mirrors 404 and the substrate 418.

In some embodiments, the mirror structure 464 may also include rigid edge bars 460 that set the mirror local slope and concentrate along the mirror longitudinal edges the torque required to obtain a constant curvature. This also results in a relaxed stiffness requirements for the substrate material 418, especially near the longitudinal edges where the internal stresses are maximal. This embodiment also encloses and protects the substrate material to protect from environmental exposure. In general, the substrate material 418 may be selected for its rigidity, stable dimensional and mechanical properties over the range of temperature and environmental conditions encountered in operation over the life of the system. the substrate 418 may have a similar thermal expansion coefficient to the glass of the mirrors 404 to avoid thermally straining and thus deforming the mirror curvature during operation. Examples of substrate 418 materials include glass foam, porous ceramic, aircrete, rigid polyurethane foam, polystyrene foam, other polymer foam, honeycomb core (e.g. aluminum, fiberglass, wood), cellulose-based foam or porous cellulose product panels. In some embodiments where the material of substrate 418 is sufficiently rigid and resilient, the mirror structure 464 may be implemented by combining only the thin glass mirror strip 404 bonded onto the substrate 418 without edge bars 460, nor back skin 462. In such an embodiment, it may be required to apply a thin sealing coating to protect porous substrate 418 and prevent degradation of its performance over time due to environmental exposure. Glass foam surfaces are prone to wear when subjected to liquid water accumulation and/or freezing.

To avoid mirror deformation while the mirror strip 400 is under bending and torsion loads, the mirrors 404 and support beam 406 are further structurally decoupled by mounting the mirrors onto the beam via a means that is mechanically compliant in the longitudinal direction and is at the same time very stiff in the transversal direction to maintain pointing accuracy. An example for such embodiment (not illustrated) would involve a plurality of thin fin flexural brackets that have a “C”-shaped or “S”-shaped cross-section, that extend in the transversal direction of the mirror strip 400 and flex in the longitudinal direction, that are bonded at the bottom to the top surface 420 of the top plate 412, and on top of which the mirrors 404 are bonded to.

In the embodiment of FIG. 4C a relatively thick layer of elastomeric adhesive 422 is used for bonding the bottom of the mirror structure 464 to the mounting surface 420. The layer of elastomeric adhesive 422 provides some compliance that further decouples the relative movement of the mirror structure 464 with respect to the mounting surface 420 to reduce distortion of the mirrors 404 due to differing thermal expansion of the material of the support beam 406 and the mirror structure 464, as well as alleviate mirror deformation due to structural coupling when the mirror strip 400 is under bending and torsion loads. Additionally, shearing of the elastomeric adhesive provides a damping mechanism for bending and torsional vibrations of the mirror strips 400.

Thin mirror glass of about 1 millimeter thick or less may be implemented in lengths of up to about 0.7 meter, which can be combined to make up a 12 meter elongate mirror strip 400 as disclosed above. The plurality of mirrors 404 are back-silvered to have a high reflectivity at solar radiation wavelengths. In this embodiment the plurality of mirrors 404 are wider than the receiver tube 112 and are shaped to reflect and focus the sun incident radiation on the receiver tube 112. Since the mirrors in this embodiment are wider than the receiver tubes 112, the mirrors are curved in the transversal direction (forming concave linear troughs) to prevent the reflected radiation bypassing the receiver tube.

The curvature in the transverse direction of the mirrors 404 is selected to focus the solar radiation onto the receiver tube 112. While an ideal curvature would be a parabolic shape, a simple circular transverse curvature may provide a satisfactory focusing performance. Each mirror strip 404 made of thin glass may be deformed during the bonding process to take up the desired curvature. It should be understood that since each individual mirror strip 400 would be spaced apart from the receiver tube 112 by a different lateral distance, each mirror strip would ideally have a different curvature such that the focused radiation falls on the receiver tube 112. A set of elongate mirror strips 400 for the solar concentrator panels 114a, and symmetrically for 114b, would thus have a transverse curvature based on an intended location of the mirror on the panel. In some embodiments the curvature may not be a smoothly varying curvature but may be a stepwise change in angle across the width of the mirror surface to provide the desired surface curvature. Alternatively, in some embodiments the width of the mirror 400 and the diameter of the receiver tubes 112 may be selected such that a flat mirror surface would result in negligible or an acceptable amount of reflected solar radiation missing the receiver tubes. In such cases, the curvature may be eliminated.

Following assembly of the mirrors 404 into rigid sandwich composite panels, the resulting mirror structure 464 are installed onto the mounting surface 420 on the top plate 412 of the support beam 406 to form the mirror strip 400.

In some embodiments, small errors in curvature may be introduced during forming of the substrate 418 or while bonding of the mirrors 404 to their substrate to form the mirror structure 464. In one embodiment, a precise convex mold (not shown) may be formed for each mirror curvature. The adhesive bonding to the substrate 418 may be performed while an outer surface of the mirror is held in the convex mold and the mirror and substrate 418 are urged into contact. The thickness of the adhesive 422 would thus accommodate any errors in the shaping of the substrate 418. The support beam 406 with the plurality of mirrors 404 attached forms the elongate mirror strip assemblies 400 that may be attached to the transverse racks 402 to complete the prefabricated solar concentrator panel 114a. A symmetrically reversed panel 114b may be constructed and configured in the same manner.

Referring back to FIG. 4B, at each location of the transverse racks 402 (FIG. 4A), a semi-circular mounting plate 430 is attached to the support beam 406. In one embodiment the mounting plates 430 and transverse racks 402 may be spaced apart longitudinally along the support beam 406 by between about 2 meters and 4 meters. Referring to FIG. 4D, each mounting plate 430 encloses an outer perimeter of the underside of the support beam 406. The mounting plate 430 thus encloses the thin-walled bottom trough 410 on all sides and extends up to the top plate 412. The mounting plates 430 may be joined to the beam by adhesive, fasteners such as rivets, or by other means. The mounting plate 430 includes a pair of semi-circular tracks 432 and 434 that together define a race 436 for receiving a plurality of rollers 438, 440, and 442. The rollers 438-442 are rotatably connected to the transverse rack 402 (shown in part in FIG. 4D) and are received within the race 436 to provide a self-aligning rolling mechanism for the mirror strip 400. A center of rotation of the race 436 is configured to be collocated along a mirror longitudinal axis 454, which is shown in FIG. 4D extending into the page along the mirror strip 404. Arranging the center of rotation for each mirror strip 404 to be at or proximate the mirror longitudinal axis 454 avoids the need for more complex rotational control of the mirror strips for tracking solar radiation incidence.

The mounting plate 430 is configured to facilitate a rotation angle from −40° to +40° or greater with respect to the angular position of the sun at noon, which enables each mirror to track the solar radiation incidence throughout the day. Each mirror strip 400 on the solar concentrator panel 114a has a different orientation with respect to the solar radiation incidence but will be rotated through the same angle changes throughout the day. As disclosed above, each solar concentrator panel 114 in the solar concentrator array 104 may include one of two panels, the panel 114a shown in FIG. 4A and a complementary panel 114b (not shown). The complementary panel 114b has an identical structure to the panel 114a but has mirror angles symmetrically reversed with respect to a vertical plane containing the receiver axis from those in the panel 114a. The panels 114a and 114b may thus only differ in the angles of the respective mirror strips 400.

Movement of the mirror strip 404 is actuated by a mirror actuator to cause rotation of the mirror strip 400 within each of the respective races 436 of the mounting plates 430. An embodiment of a mirror actuator that is connected to the river plate 408 is shown in FIG. 4E. Referring to FIG. 4E, as disclosed above the rivet plate 408 connects between the support beam section 406″ and the support beam section 406′ (not shown in FIG. 4E). The rivet plate 408 includes a pair of spaced apart plates 470 and 472 that depend downwardly from the rivet plate 408 and define a channel 474 on an underside of the rivet plate. The mirror actuator in this embodiment includes a lever arm 476 having an end 478 received within the channel 474. The plate 470 includes an arcuate slot 480 that provides access to a pair of openings 482 in the end 478 of the lever arm 476. The plate 472 also includes a corresponding slot (not visible in FIG. 4E) and the lever arm 476 may be fixed within the channel by two fasteners (not shown). The fasteners may be bolts or rivets that extend through the slot 480 and the corresponding slot on the plate 472. The slots in the plates 470 and 472 provide for positioning of the lever arm 476 within the slot to adjust an offset angle O between the lever arm 476 and a vertical axis of the mirror strip 400. The offset angle O sets an initial orientation of each mirror strip 400 with respect to the solar radiation incidence.

The mirror actuator also includes an actuator bar 484, which is connected to the lever arm 476 at a pivot 486. Each of the mirror strips 400 of the panels 114a or 114b are similarly configured and have respective lever arms 476 connected at the rivet plate 408 and connected to the common actuator bar 484. The actuator bar 484 may in turn be connected via mechanical couplings to a drive shaft (not shown) that runs longitudinally through the solar concentrator array 104 for actuating a plurality of solar concentrator panels 114a. In some embodiments, the mechanical couplings may further be configured to cause both the panels 114a and 114b to be driven from a single drive shaft. In some embodiments the actuator bar 450 and mechanical couplings may be included as part of the prefabricated solar concentrator panel 114a. The actuator bar 484 may thus be moved over time in a direction indicated by the arrow 488 to track the incidence angle of the solar radiation, thus causing the mirror to remain focused on the receiver tube 112 throughout the day. The remaining mirror strips 400 are similarly configured, each having a different initial angle with respect to the receiver tube 112 but moving through the same angular changes in response to movement of the actuator bar 484.

The actuator bar 484 may be actuated automatically via a drive and gearing system that causes the mirror strips 400 in each solar concentrator panel 114a and 114b to automatically track the solar radiation for any location and time of year.

In other embodiments the lever arm 476 may be attached to the support beam 406 of the mirror strip 400 at a different location to that shown in FIG. 4E. Additionally, adhesive may be used in place of a fastener to bond the lever arm 476 to the support beam 406.

When the lever arm 476 for each mirror strip 400 is connected to the actuator bar 484, a manufacturing angular error may possibly be introduced. This error may be mitigated by simultaneously punching the pivot 486 in the actuator bar 484 and riveting the lever arm 476 to the pivot for each lever arm while the mirror is held in a jig at a desired angle. The jig may be configured for serially aligning each individual mirror 400 or the jig may be configured to hold the plurality of mirrors in alignment at the same time.

The solar concentrator panels 114 may be prefabricated off-site generally as shown in FIG. 4A and a plurality of the panels may shipped in the stacked configuration 380 shown in FIG. 3C. This has the advantage of avoiding on-site assembly of the elongate mirror strips 400 to form the solar concentrator array 104. The solar concentrator panels 114 are vertically compact, which has the advantage of optimizing the number of panels that can be shipped in the stacked configuration 380.

In one embodiment, the actuator lever arm 476 for each individual mirror strip 400 may be precisely adjusted at the time of manufacturing the solar concentrator panels 114a and 114b. Each individual mirror strip 400 may be aligned using a precision jig or other measurement system and the end 478 of the lever arm 476 secured in the slots to the plates 470 and 472 of the rivet plate 408 using a fastener as described above. This process may thus be used to set the individual angle e for each mirror strip 404 in a solar concentrator panel 114a or 114b.

One disadvantage of configuring the angles of the mirror strips 400 at the time of manufacturing is that the lever arms 476 limit how closely panels 114a or 114b can be stacked for shipping in the configuration 380 shown in FIG. 3C. For the embodiment shown in FIG. 4E, the slots in the plates 472 and 474 allow the lever arms 476 to be rotated to reduce the stacking height of each panel 114a or 114b. Alternatively the lever arms 476 may be shipped disconnected from the panel. In either case the angle of each mirror strip 400 would need to be aligned and fixed in place by installing and aligning the lever arms 476 at the installation site 300. Generally, the actuator bars 484 for each of the panels 114a and 114b will also need to be connected together after unloading from the stacked configuration 380 and before placement in the solar concentrator array 104.

In some embodiments, the actuator bar 484 of a pair of panels 114a and 114b may be further connected to an actuator associated with one or more adjacent panels 114, and the respective actuator bars may be coupled to a single drive shaft. In this case, the connection between the adjacent actuator bars 450 may include provisions for adjusting the relative angular positions of the respective mirrors strips 400 of the adjacent panels 114 so that each panel is configured to track the incident solar radiation.

The above disclosed embodiments have the advantage of streamlining the site installation to facilitate implementation of automated installation processes. Components of the structural frame 120 and solar concentrator array 104 are generally configured to be lightweight and as compact as possible to reduce shipping volume and weight, as well as to minimize material costs and installation costs. The solar concentrator panels 114 may be configured to arrive on site substantially complete and aligned and thus ready for deployment. This avoids the need for further assembly and alignment on site. The mobile manipulator 308 is configured to be supported on the structural frame 120, thus reducing the need for terrain preparation at the site while at the same time maximizing usage of the land surface area.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, or within less than 0.01% of the stated value.

While specific embodiments have been described and illustrated, such embodiments should be considered illustrative only and not as limiting the disclosed embodiments as construed in accordance with the accompanying claims.

1. A solar energy harvesting system comprising:
a plurality of beams connected to form a structural frame;
a plurality of solar concentrator panels mounted on the structural frame to provide a solar concentrator array configured to reflect solar radiation onto a plurality of receiver tubes, the plurality of receiver tubes being configured to transport a heat transfer fluid to be heated by the solar radiation; and
wherein the plurality of beams are configured to support a mobile manipulator for travel along the structural frame, the mobile manipulator being configured to perform at least one operation on the solar concentrator array.

2. The system of claim 1 wherein the plurality of beams comprise:
a plurality of regularly spaced apart longitudinally extending rail beams; and
a plurality of cross beams connecting between adjacent rail beams.

3. The system of claim 2 wherein the plurality of solar concentrator panels are mounted between adjacent pairs of rail beams to provide the solar concentrator array.

4. The system of claim 2 wherein the rail beams are configured to guide and support the mobile manipulator straddled between an adjacent pair of rail beams for travel along the rail beams.

5. The system of claim 1 wherein the plurality of beams are connected to provide a continuously connected structural frame.

6. The system of claim 1 wherein the structural frame comprises a plurality of mounting locations and wherein an associated plurality of posts are disposed at an operating site to support the structural frame at respective mounting locations in a desired orientation with respect to an incidence path of the solar radiation.

7. The system of claim 6 wherein the plurality of beams comprise longitudinally extending rail beams and transversely extending cross beams and wherein:
at least one mounting location is configured to anchor the structural frame in fixed relation to the associated post;
at least one mounting location is configured to constrain transverse movement of the rail beams while facilitating longitudinal movement to accommodate thermal expansion or contraction of the rail beams; and
at least one mounting location is configured to constrain longitudinal movement of the cross beams while facilitating transverse movement to accommodate thermal expansion or contraction of the cross beams.

8. The system of claim 6 wherein the mobile manipulator comprises a height actuator and wherein each mounting location includes a height adjustment configured to be engaged by the height actuator for adjusting a height of the mounting location to level the structural frame.

9. The system of claim 8 wherein the mobile manipulator is configured to generate height alignment signals for aligning the level of the structural frame in a desired orientation with respect to the incidence path of the solar radiation and wherein the height actuator is responsive to the height alignment signals for adjusting the height of the mounting location.

10. The system of claim 1 wherein the plurality of beams comprise a plurality of longitudinally extending rail beams configured to support the mobile manipulator for travel along an adjacent pair of rail beams and further comprising a feeder track disposed running transversely alongside the rail beams, the feeder track being configured to facilitate positioning the mobile manipulator to access the adjacent pair of rail beams.

11. The system of claim 10 further comprising a staging track disposed to provide access between a loading location and the feeder track to facilitate movement of the mobile manipulator onto the feeder track.

12. The system of claim 11 wherein the staging track provides access to a plurality of loading locations disposed in proximity to the staging track and wherein the mobile manipulator is configured to access any of the plurality of loading locations for loading components.

13. The system of claim 11 wherein the mobile manipulator includes an end effector, the mobile manipulator being configured to:
manipulate the end effector to load one or more components of the solar array at the loading location;
transport the one or more components via the staging track to a position on the feeder track that provides access to an adjacent pair of rail beams for movement to an open location within the solar concentrator array;
travel along the adjacent pair of rail beams to align with the open location; and
manipulate the end effector to place the one or more components into engagement with the structural frame at the open location.

14. The system of claim 11 wherein the plurality of solar concentrator panels each comprise a prefabricated solar concentrator panel and wherein the end effector comprises a panel end effector configured to manipulate one or more of the prefabricated solar concentrator panels.

15. The system of claim 14 wherein the end effector is configured to cause one of independent vertical manipulation and simultaneous vertical manipulation of two prefabricated solar concentrator panels.

16. The system of claim 14 wherein the structural frame includes attachment features that are configured to engage with corresponding attachment features on the prefabricated solar concentrator panels to secure the panels in fixed engagement with the structural frame.

17. The system of claim 14 wherein the staging track includes an end disposed to provide access to a loading location and wherein the mobile manipulator is configured to use the panel end effector to load one or more of the prefabricated solar concentrator panels from a stacked plurality of prefabricated solar concentrator panels disposed at the loading location.

18. The system of claim 13 wherein the mobile manipulator includes a quick mount connection for mounting one of a plurality of end effectors.

19. The system of claim 17 wherein the stacked plurality of prefabricated solar concentrator panels comprise prefabricated solar concentrator panels supported by a transport frame configured to support and protect the prefabricated solar concentrator panels during shipping and to facilitate loading by the mobile manipulator.

20. The system of claim 13 wherein the receiver tube is configured to be mounted to a plurality of receiver tube supports connected between adjacent pairs of rail beams and wherein the end effector comprises a receiver tube support end effector configured to manipulate one or more of the receiver tube supports.

21. The system of claim 20 wherein the structural frame includes receiver tube support attachment features that are configured to engage with corresponding attachment features on the one receiver tube support to secure the receiver tube support to the adjacent pair of rail beams.

22. The system of claim 13 wherein the end effector comprises a receiver tube end effector configured to manipulate one or more receiver tubes.

23. The system of claim 22 wherein the mobile manipulator comprises an orbital welder configured to fluidly connect the receiver tube to another already placed receiver tube.

24. The system of claim 1 wherein the mobile manipulator comprises:
a drive actuator coupled to one or more wheels of the mobile manipulator to cause the mobile manipulator to travel along the structural frame in response to drive actuator signals;
one or more sensors disposed to generate alignment signals with respect to the structural frame; and
a controller in communication with the drive actuator and the one or more sensors, the controller being configured to generate the drive actuator signals for controlling movements of the mobile manipulator based on the alignment signals.

25. The system of claim 1 wherein the mobile manipulator comprises a gantry straddling the adjacent pair of adjacent rail beams and wherein the mobile manipulator comprises one or more end effectors configured to perform the at least one operation on the solar concentrator array.

26. The system of claim 1 wherein the mobile manipulator is configured to perform one or more of:
an installation operation;
a transport operation;
a cleaning operation;
an inspection operation;
an alignment adjustment;
a repair operation; or
a maintenance operation.

27. The system of claim 1 wherein each of the plurality of solar concentrator panels comprise a plurality of adjacent elongate mirror strips, each mounted to a transverse rack, each mirror strip comprising:
a mirror structural support having an elongate upper surface;
a plurality of mirrors mounted to the upper surface, each mirror having a curvature in the transverse direction that is selected to focus the solar radiation onto a portion of the plurality receiver tubes; and
wherein the structural support is configured for rotation on the transverse rack with respect to the solar radiation to cause the mirrors to direct the solar radiation toward respective portions of the plurality of receiver tubes.

28. The system of claim 27 further comprising a mirror actuator coupled to the mirror structural support, the mirror actuator being configured to cause rotation of the mirror structural support based on a changing angle of incidence of the solar radiation for directing the reflected solar radiation toward the portion of the plurality of receiver tubes.

29. The system of claim 28 wherein for each individual mirror strip in the solar concentrator panel, the mirror actuator is connected to the mirror structural support to align the individual mirror at an angle with respect to the angle of other mirrors in the panel to reflect solar radiation onto the receiver tube.

30. The system of claim 1 wherein the mobile manipulator comprises a plurality of wheels configured to engage a portion of the rail beams that remains exposed after the plurality of solar concentrator panels have been mounted between adjacent pairs of rail beams to provide the solar concentrator array, the exposed portion of the rail beams being operable to facilitate travel of the mobile manipulator along the rail beams for performing operations on the solar concentrator array following mounting of the solar concentrator panels.

31. A method for performing operations on a structural frame disposed to support a solar concentrator array, the solar concentrator array including a plurality of solar concentrator panels, the method comprising:
supporting a mobile manipulator for travel along the structural frame;
causing the mobile manipulator to travel along the structural frame to a location on the structural frame at which at least one operation associated with the solar concentrator array is to be performed; and
causing the mobile manipulator to perform the at least one operation at the location.

32. The method of claim 31 wherein causing the mobile manipulator to perform the at least one operation comprises causing the mobile manipulator to perform one or more of:
an installation operation;
a transport operation;
a cleaning operation;
an inspection operation;
an alignment adjustment;
a repair operation; or
a maintenance operation.

33. The method of claim 31 further comprising receiving signals from one or more sensors disposed to generate alignment signals with respect to the structural frame and causing a controller to generate the drive actuator signals for controlling movements of the mobile manipulator based on the alignment signals.

34. The method of claim 31 wherein the plurality of beams comprise a plurality of regularly spaced apart longitudinally extending rail beams and a plurality of cross beams connecting between adjacent rail beams and wherein supporting a mobile manipulator for travel along the structural frame comprises receiving and supporting the mobile manipulator straddled between an adjacent pair of rail beams for travel along the rail beams.

35. The method of claim 34 wherein causing the mobile manipulator to travel along the structural frame comprises causing the mobile manipulator to travel along a feeder track disposed running transversely alongside the rail beams and causing the mobile manipulator to align with the adjacent pair of rail beams to access the structural frame.

36. The method of claim 35 wherein the structural frame further comprises a staging track disposed to provide access between a loading location and the feeder track to facilitate movement of the mobile manipulator onto the feeder track and further comprising:
manipulating an end effector of the mobile manipulator to load one or more components of the solar array at the loading location;
transporting the one or more components via the staging track to a position on the feeder track that provides access to an adjacent pair of rail beams for movement to an open location within the solar concentrator array;
causing the mobile manipulator to travel along the adjacent pair of rail beams to align with the open location; and
causing the mobile manipulator to manipulate the end effector to place the one or more components into engagement with the structural frame at the open location.

37. The method of claim 31 wherein the plurality of solar concentrator panels each comprise a prefabricated solar concentrator panel and wherein causing the mobile manipulator to perform the at least one operation at the location comprises causing the mobile manipulator to manipulate the prefabricated solar concentrator panel to cause the prefabricated solar concentrator panel to engage with the structural frame an open location of the structural frame.

38. A solar energy harvesting system comprising:
a plurality of beams connected to form a structural frame;
a plurality of solar concentrator panels mounted on the structural frame to provide a solar concentrator array configured to reflect solar radiation onto a plurality of receiver tubes, the plurality of receiver tubes being configured to transport a heat transfer fluid to be heated by the solar radiation; and
a plurality of posts disposed at an operating site to support the structural frame at respective mounting locations;
wherein at least some of the plurality of posts include a height adjustment actuable to facilitate adjustment of a height of the mounting location to orient the structural frame in a desired orientation with respect to an incidence path of the solar radiation.

39. The system of claim 38 wherein each height adjustment is configured to be engaged by a height actuator for adjusting a height of the mounting location.

40. The system of claim 39 wherein the plurality of beams are configured to support a mobile manipulator for travel along the structural frame, and wherein the height actuator is disposed on the mobile manipulator.

41. The system of claim 40 wherein the mobile manipulator is configured to generate height alignment signals for aligning the structural frame in the desired orientation and wherein the height actuator is responsive to the height alignment signals for adjusting the height of the mounting location.

42. The system of claim 40 wherein the mobile manipulator comprises:
a drive actuator coupled to one or more wheels of the mobile manipulator to cause the mobile manipulator to travel along the structural frame in response to drive actuator signals;
one or more sensors disposed to generate alignment signals with respect to the structural frame; and
a controller in communication with the drive actuator and the one or more sensors, the controller being configured to generate the drive actuator signals for controlling movements of the mobile manipulator based on the alignment signals.

43. The system of claim 38 wherein the desired orientation with respect to an incidence path of the solar radiation comprises a substantially level condition of the structural frame.

44. A method for leveling a structural frame at an operating site, the structural frame including a plurality of connected beams supported at mounting locations by a plurality of posts, the method comprising:
automatically actuating a height adjustment associated with at least some of the plurality of posts to adjust a height of the mounting location for orienting the structural frame in a desired orientation.

45. The method of claim 44 wherein each height adjustment is configured to be engaged by a height actuator for adjusting a height of the mounting location.

46. The method of claim 45 wherein the plurality of beams are configured to support a mobile manipulator for travel along the structural frame, and wherein the height actuator is disposed on the mobile manipulator.

47. The method of claim 46 wherein the mobile manipulator is configured to generate height alignment signals for aligning the structural frame in the desired orientation and wherein the height actuator is responsive to the height alignment signals for adjusting the height of the mounting location.

48. The method of claim 44 wherein the automatically actuating the height adjustment is performed at a time of installation of the structural frame and at a subsequent time when the automatically adjusting is repeated to compensate for changes in operating site terrain.

49. The method of claim 45 wherein the structural frame is configured to support a plurality of solar concentrator panels to provide a solar concentrator array configured to reflect solar radiation onto a plurality of receiver tubes, the plurality of receiver tubes being configured to transport a heat transfer fluid to be heated by the solar radiation.

50. A solar energy harvesting system comprising:
a plurality of beams connected to form a structural frame;
a plurality of solar concentrator panels mounted on the structural frame to provide a solar concentrator array configured to reflect solar radiation onto a plurality of receiver tubes, the plurality of receiver tubes being configured to transport a heat transfer fluid to be heated by the solar radiation; and
wherein the plurality of beams are configured to support a mobile cart for travel along the structural frame to provide access to the solar concentrator array.

51. A mirror strip apparatus used in a solar concentrator panel for collecting solar radiation, the mirror strip apparatus comprising:
an elongate thin-walled closed box structural beam; and
a mirror extending along and mounted to a surface of the structural beam in a transversely deformed condition to cause the mirror to have a transverse curvature that is selected to reflect and concentrate the solar radiation onto a receiver tube, the receiver tube being configured to transport a heat transfer fluid to be heated by the reflected and concentrated solar radiation.

52. The apparatus of claim 51 wherein the deformed condition causes the mirror to have one of a circular or a substantially parabolic transverse curved shape.

53. The apparatus of claim 51 wherein the mirror is bonded to a substrate having a similar coefficient of thermal expansion as the mirror.

54. The apparatus of claim 53 wherein the substrate is formed to provide the transversely deformed condition.

55. The apparatus of claim 53 wherein the substrate comprises one of a glass foam, a porous ceramic, aircrete, a polyurethane foam, a polystyrene foam, a polymer foam, a honeycomb core, a cellulose-based foam, or a compressed cellulose product panel.

56. The apparatus of claim 51 wherein the mirror is mounted to the surface of the structural beam via a plurality of flexures, the flexures configured to provide:
sufficient compliance in a longitudinal direction to facilitate a difference between thermal expansion of the structural beam and the mirror; and
sufficient transverse stiffness to maintain an accurate relative angular positioning of the mirror with respect to the structural beam.

57. The apparatus of claim 51 wherein the mirror is mounted to the surface of the structural beam via a layer of elastomeric adhesive, the layer of elastomeric adhesive configured to provide:
sufficient compliance in a longitudinal direction to facilitate a difference between thermal expansion of the structural beam and the mirror; and
sufficient transverse stiffness to maintain an accurate relative angular positioning of the mirror with respect to the structural beam.

58. The apparatus of claim 57 wherein the layer of elastomeric adhesive is further configured to dissipate energy caused by structural beam vibrations.

59. The apparatus of claim 51 wherein the structural beam comprises a mounting plate for mounting the structural beam in the solar concentrator panel, the mounting plate configured to provide for rotation of the structural beam about a longitudinal axis extending along a front surface of the mirror.

60. The apparatus of claim 59 wherein the mounting plate is configured for rotation through an angle of at least about +40° to at least about −40° with respect to its angular position at noon to track the incidence angle of the solar radiation through daylight hours at an operating location of the solar concentrator panel.

61. The apparatus of claim 59 wherein the mounting plate comprises a semi-circular race configured to receive at least two bearings on the solar concentrator panel.

62. The apparatus of claim 61 wherein the race and bearings are configured to provide for self-aligning rotation of the mirror about the longitudinal axis of the structural beam.

63. The apparatus of claim 51 wherein the structural beam comprises one of a rectangular, trapezoidal, semicircular, or irregular cross section.

64. The apparatus of claim 51 wherein the structural beam encloses an interior volume defined by the walls of the beam and wherein the interior volume is at least partially filled by a low-density core material.

65. The apparatus of claim 64 wherein the low-density core material is bonded to the structural beam.

66. The apparatus of claim 51 wherein a width of the mirror and height of the structural beam are selected to minimize excitation of the beam structural modal frequencies by vortex shedding at frequencies caused by wind circulating over the mirror in a transverse direction.

67. The apparatus of claim 51 wherein a width of the mirror and height of the structural beam are selected to minimize excitation of the beam structural modal frequencies by vortex shedding at frequencies caused by wind travelling over the mirror in a transverse direction.

68. The apparatus of claim 67 wherein a width of the mirrors and dimensions of the structural beam are selected to maximize packing efficiency for shipping the apparatus.

69. The apparatus of claim 68 further comprising a lever arm connected to the structural beam, the lever arm being configured to couple to an actuator for changing an angle of the mirror to reflect the solar radiation onto the receiver tube.

70. The apparatus of claim 69 wherein the lever arm is connected to the structural beam via a hinged connection to facilitate collapsing the lever arms into to maximize packing efficiency for shipping the apparatus.

71. A set of mirrors for a solar concentrator panel, each mirror in the set of mirrors configured in accordance with claim 51 and having a transverse curvature based on an intended location of the mirror on the solar concentration panel.
